(19) United States
(12) Patent Application Publication
(10) Pub. No.: US 2002/0012096 A1
(43) Pub. Date: Jan. 31, 2002

(54) Manufacturing method for manufacturing electro-optical device, connection method for connecting terminals, electro-optical device, and electronic equipment

(76) Inventor: Kenji Uchiyama, Nagano-ken (JP)

Correspondence Address: HARNESS, DICKEY & PIERCE, PLC, P.O. BOX 828, BLOOMFIELD HILLS, MI, 48303, US

(21) Appl. No.: 09/853,083

(22) Filed: May 10, 2001

(30) Foreign Application Priority Data
May 12, 2000 (JP) 2000-140540(P)
Mar. 19, 2001 (JP) 2001-078901(P)

(51) Int. Cl. G02F 1/13

(52) U.S. Cl. 349/187

(57) ABSTRACT

A substrate 6a having terminals 9 thereon is bonded to a wiring board 11 having output terminals 11c thereon through an ACP 20. The pitch P2 of the output terminals 11c is different from the pitch P1 of the terminals 9 taking into account deformation of the substrate 6a or the wiring board 11 during bonding. When the substrate 6a or the wiring board 11 deforms during the bonding, the both terminals are connected with the pitch P1′ of the terminals 9 and the pitch P2′ of the output terminals 11c becoming approximately equal to each other.

### BACKGROUND OF THE INVENTION

1. Technical Field of the Invention

The present invention relates to an electro-optical device, electronic equipment, and a manufacturing method for manufacturing the electro-optical device and, more particularly, to a technique for connecting terminal banks respectively formed on a plurality of base members.

2. Description of the Related Art

Electro-optical devices, such as a liquid-crystal display device, and an electroluminescence (EL) device, find widespread use in displays of a variety of electronic equipment such as mobile telephones and mobile information terminals. The electro-optical device is typically used to present characters, numerals and pictures.

The electro-optical device of this sort typically includes a substrate holding an electro-optical material, and electrodes, arranged on the substrate, for supplying a voltage to the electro-optical material. In the liquid-crystal device employing a liquid crystal as an electro-optical material, an electrode for applying a voltage to the liquid crystal is formed on a surface of one of a pair of substrates holding the liquid crystal therebetween, facing the other of the pair. By controlling the voltage applied to the liquid crystal, the alignment of the liquid crystal is controlled to modulate light transmitted through the liquid crystal.

The electro-optical device typically employs a driver IC chip for outputting a drive signal to the electrode. The driver IC chip is mounted on a flexible board that is bonded to the substrate, for example. A wiring pattern formed on the flexible board and electrode terminals are typically connected to terminals arranged on the substrate of the electro-optical device via an conductive adhesive compound such as an ACF (Anisotropic Conductive Film). The ACF is produced by dispersing conductive particles in an adhesive resin. Specifically, the substrate of the electro-optical panel and the flexible board are bonded to each other by the adhesive resin in the ACF while the terminals of the substrate of the electro-optical panel are electrically connected to the terminals of the flexible board via the conductive particles. In a bonding step for bonding the substrate of the electro-optical panel to the flexible board using the ACF, the flexible board is thermal compression bonded to the electro-optical panel with the ACF interposed therebetween.

Since the flexible board is thermally expanded in the above-mentioned thermal compression bonding step, the positions of the terminals on the flexible board shift from those prior to the thermal compression bonding. If the terminals suffer from position shifting, each terminal may connect to a wrong terminal which may be next to an originally intended right one, or may straddle and be connected to a plurality of terminals. The reliability of terminal connection is thus reduced. Such a problem may be serious when the terminals formed on the substrate of the electro-optical panel are arranged in a fine pitch.

In view of the above problem, the present invention has been developed. It is an object of the present invention to provide a manufacturing method for manufacturing an electro-optical device that improves connection reliability between terminals on a substrate and terminals on a mount base member, a connection method for the terminals, an electro-optical device, and electronic equipment.

### SUMMARY OF THE INVENTION

To resolve the above problem, the present invention relates to a manufacturing method for manufacturing an electro-optical device having an electro-optical panel with a substrate holding an electro-optical material and a mount base member bonded to the substrate, and includes a step of connecting a first terminal bank, formed on the surface of the substrate, to a second terminal bank formed on the surface of the mount base member at a pitch different from a pitch of the first terminal bank when the substrate is bonded to the mount base member, wherein the connection step connects the first terminal bank and the second terminal bank, both of which become substantially equal to each other in pitch when the substrate and the mount base member are deformed during the bonding of the substrate and the mount base member.

In this manufacturing method, the pitches of the first terminal bank and the second terminal bank are made different taking into consideration the deformation (a stretch or a shrinkage) of the substrate and the mount base member. The first terminal bank and the second terminal bank are correctly connected to each other even if one of the substrate and the mount base member deforms when the substrate is bonded to the mount base member. Specifically, this arrangement prevents the two terminal banks from relatively moving from each other during the connection of the terminal banks even if the pitches of the first terminal bank and the second terminal bank vary in response to the deformation of the substrate and the mount base member. Since the substrate and the mount base member typically have a number of fine pitched terminals in the electro-optical device, the effect of the deformation of the substrate or the mount base member is significant on interconnection reliability between the first terminal bank and the second terminal bank. For this reason, the present invention is particularly useful when the present invention is applied to an electro-optical device that requires the connection of fine-pitched terminals.

Preferably, a alignment step for aligning the substrate with the mount base member is performed prior to the connection step so that a plurality of first alignment marks mutually spaced apart on the surface of the substrate registers with a plurality of second alignment marks mutually spaced apart on the surface of the mount base member at a spacing approximately equal to a spacing of the plurality of first alignment marks. Specifically, preferably, the pitches of the first terminal bank and the second terminal bank are made different prior to the bonding of the substrate to the mount base member while the spacing of the plurality of first alignment marks on the substrate is substantially equal to the spacing of the plurality of second alignment marks on the mount base member when the substrate is aligned with the mount base member prior to the bonding. The position of the substrate relative to the mount base member prior to the connection step is adjusted so that the first alignment marks respectively register with the second alignment marks. The alignment of the substrate and the mount base member is easily performed in this way. Subsequent to the connection step, the spacing of the first alignment marks becomes different from the spacing of the second alignment marks when the substrate and the mount base member are deformed. As long as the two spacings are equal to each other at the time of alignment, no problem is caused even if the two spacings become different subsequent to the connection step.

Preferably, in the connection step, the substrate and the mount base member are bonded together with an adhesive layer interposed between the substrate and the mount base member by heating the adhesive layer. The substrate and the mount base member are bonded while the first terminal bank and the second terminal bank are connected to each other at a time. The manufacturing yield of the device is thus improved. When the components are bonded in this way, the first base member and the second base member are subject to thermal distortion with the adhesive layer heated. In accordance with the present invention, the pitches of the first terminal bank and the second terminal bank are determined taking into consideration such thermal distortion. Regardless of thermal distortion, the first terminal bank and the second terminal bank are correctly connected. For example, when the linear thermal expansion coefficient of the second base member is larger than the linear thermal expansion coefficient of the first base member, the pitch of the second terminal bank may be set to be smaller than the pitch of the first thermal bank prior to the bonding.

Specifically, preferably, the mount base member is a member having a thickness within a range from 50 μm to 125 μm and a linear thermal expansion coefficient falling within a range from 2.5×10⁻⁵/K to 2.6×10⁻⁵/K under a measurement temperature range from 100° C. to 200° C., and the pitch of the second terminal bank is 0.996 times to 0.997 times the pitch of the first terminal bank. Preferably, the mount base member is a member having a thickness within a range from 5 μm to 75 μm and a linear thermal expansion coefficient falling within a range from 0.8×10⁻⁵/K to 1.0×10⁻⁵/K under a measurement temperature range from 20° C. to 100° C., and the pitch of the second terminal bank is approximately 0.998 times the pitch of the first terminal bank.

The substrate may contain a material selected from the group consisting of glass and silicon, and the mount base member may contain a material selected from the group consisting of polyimide and polyester. When the substrate and the mount base member are manufactured of the above combined materials, particularly when the substrate containing glass and the mount base member containing polyimide are used, the present invention has a substantial advantage because there occurs a large amount of thermal distortion between the substrate and the mount base member (i.e., a large difference between the linear thermal expansion coefficients).

To resolve the previously discussed problem, a terminal connection method of the present invention for connecting a first terminal bank formed on the surface of a first base member to a second terminal bank formed on the surface of a second base member, includes fabricating the second terminal bank at a pitch different from a pitch of the first terminal bank, and connecting the first terminal bank and the second terminal bank, both of which become substantially equal to each other in pitch when the first base member and the second base member are deformed during the bonding of the first base member to the second base member.

In this method, the pitches of the first terminal bank and the second terminal bank are made different taking into consideration the deformation (a stretch or a shrinkage) of the first base member and the second base member. The first terminal bank and the second terminal bank are correctly connected to each other even if one of the first base member and the second base member deforms when the first base is bonded to the second base member. Specifically, this arrangement prevents the two terminal banks from relatively moving from each other during the connection of the terminal banks even if the pitches of the first terminal bank and the second terminal bank vary in response to the deformation of the first base member and the second base member.

Preferably, in the bonding of the first base member to the second base member, the first base member and the second base member are bonded together with an adhesive layer interposed between the first base member and the second base member by heating the adhesive layer. The two base members are reliably bonded while the first terminal bank and the second terminal bank are connected to each other at a time. The manufacturing yield of the device is thus improved. When the components are bonded in this way, the first base member and the second base member are subject to thermal distortion with the adhesive layer heated. In accordance with the present invention, the pitches of the first terminal bank and the second terminal bank are determined taking into consideration such thermal distortion. Regardless of thermal distortion, the first terminal bank and the second terminal bank are correctly connected. For example, when the linear thermal expansion coefficient of the second base member is larger than the linear thermal expansion coefficient of the first base member, the pitch of the second terminal bank may be set to be smaller than the pitch of the first thermal bank prior to the bonding.

To resolve the above-referenced problem, a manufacturing method of the present invention for manufacturing a mount base member having a second terminal bank to be connected to a first terminal bank formed on a base member and being thermal-compression bonded to the base member, includes the step of forming the second terminal bank in such a manner that the pitch of the second terminal bank is a/b times the pitch of the first terminal bank, when, subsequent to the thermal compression bonding of the mount base member to the base member, the first terminal bank expands in width in the transverse direction thereof on the base member by a times and the second terminal bank expands in width in the transverse direction thereof on the mount base member by b times.

In accordance with this method, the terminals formed on both base members are connected to each other with a high accuracy even if the two base members are deformed in the bonding step for bonding the mount base member to the other base member. Specifically, the pitch Pi of the first terminal bank changes to a pitch P1×a subsequent to the thermal compression bonding. The pitch P2=P1×(a/b) changes to a pitch P2×b, namely, a pitch P1×a subsequent to the thermal compression bonding. The pitch of the first terminal bank becomes approximately equal to the pitch of the second terminal bank. Regardless of the thermal distortion, both terminal banks are correctly connected. The coefficients a and b defining the pitch of the second terminal bank are values accounting for the linear thermal expansion coefficients of the mount base member and conditions of thermal expansion bonding. The statement that the pitch of the second terminal bank is a/b times the pitch of the first terminal bank means that the pitch of the second terminal bank is equal to or greater than (a/b−0.001) times and equal to or smaller than (a/b+0.001) times the pitch of the first terminal bank.

To resolve the previously described problem, an electro-optical device of the present invention includes an electro-optical panel including a substrate holding an electro-optical material, a mount base member bonded to the substrate, a first terminal bank formed on the surface of the substrate, a plurality of first alignment marks formed and mutually spaced apart on the surface of the substrate, a second terminal bank formed and mutually spaced apart on the mount base member, wherein the second terminal bank is connected to the first terminal bank at a pitch thereof substantially equal to the pitch of the first terminal bank, and a plurality of second alignment marks formed on the surface of the mount base member, and spaced mutually more apart than spacing of the first alignment marks.

In the above electro-optical device, deformation of one of the base member and the mount base member when the substrate is bonded to the mount base member is accounted for in the determination of the pitch of one of the first terminal bank and the second terminal bank. The spacing of the first alignment marks and the spacing of the second alignment marks prior to the bonding are set so that the substrate and the mount base member are easily aligned, in other words without paying attention to the deformation of one of the substrate and the mount base member. The first terminal bank and the second terminal bank are thus connected with a high accuracy through a simple alignment operation.

Preferably, in the electro-optical device, one group of the plurality of first alignment marks and the other group of the plurality of first alignment marks are arranged to be opposed to each other with the first terminal bank interposed therebetween, and one group of the plurality of second alignment marks and the other group of the plurality of second alignment marks are arranged to be opposed to each other with the second terminal bank interposed therebetween. By allowing the alignment marks to interpose the terminal bank therebetween, the substrate and the mount base member are positioned with a high accuracy.

Preferably, the substrate and the mount base member are bonded to each other with an adhesive layer therebetween, and the adhesive layer contains conductive particles dispersed therewithin to conductively connect the first terminal bank to the second terminal bank. The first terminal bank and the second terminal bank are reliably conductively connected with the substrate and the mount base member firmly bonded with the adhesive layer therebetween. The first terminal bank and the second terminal bank are connected with a high accuracy even if one of the substrate and the mount base member is deformed when the adhesive layer is heated during the bonding of the substrate to the mount base member.

The substrate may contain a material selected from the group consisting of glass and silicon, and the mount base member may contain a material selected from the group consisting of polyimide and polyester. When the substrate and the mount base member are manufactured of the above combined materials, particularly when the substrate containing glass and the mount base member containing polyimide are used, the present invention has a substantial advantage because there occurs a large amount of thermal distortion between the substrate and the mount base member. For example, the mount base member is a member having a thickness within a range from 50 μm to 125 μm and a linear thermal expansion coefficient falling within a range from 2.5×10⁻⁵/K to 2.6×10⁻⁵/K under a measurement temperature range from 100° C. to 200° C., and the spacing of the second alignment marks is preferably 1.003 times to 1.004 times the spacing of the first alignment marks. When the mount base member is a member having a thickness within a range from 5 μm to 75 μm and a linear thermal expansion coefficient falling within a range from 0.8×10⁻⁵/K to 1.0×10⁻⁵/K under a measurement temperature range from 20° C. to 100° C., the spacing of the second alignment marks is preferably approximately 1.002 times the spacing of the first alignment marks.

To resolve the previously described problem, electronic equipment of the present invention includes the above-referenced electro-optical device. The electro-optical device of the present invention enables the first terminal bank and the second terminal bank to be connected with a high accuracy by compensating for the thermal distortion taking place during the bonding of the substrate to the mount base member. The electronic equipment incorporating the electro-optical device is free from a connection failure and offers greater reliability.

To resolve the previously described problem, the present invention relates to a mount base member to be thermal compression bonded to a substrate of an electro-optical panel, and includes a second terminal bank to be connected to a first terminal bank formed on the substrate, wherein the pitch of the second terminal bank prior to the thermal compression bonding is a/b times the pitch of the first terminal bank, when, subsequent to the thermal compression bonding of the mount base member to the substrate, the first terminal bank expands in width in the transverse direction thereof on the substrate by a times and the second terminal bank expands in width in the transverse direction thereof on the mount base member by b times. Even when the mount base member expands during the bonding of the mount base member to the substrate, the first terminal bank and the second terminal bank are connected with a high accuracy. The statement that the pitch of the second terminal bank is a/b times the pitch of the first terminal bank means that the pitch of the second terminal bank is equal to or greater than (a/b−0.001) times and equal to or smaller than (a/b+0.001) times the pitch of the first terminal bank.

For example, the pitch P1 of the first terminal bank changes to a pitch P1×a subsequent to the thermal compression bonding. The pitch P2=P1×(a/b) of the second terminal bank changes to a pitch P2×b, namely, a pitch P1×a subsequent to the thermal compression bonding. The pitch of the first terminal bank becomes approximately equal to the pitch of the second terminal bank. Regardless of the thermal distortion, both terminal banks are correctly connected. When the substrate of the electro-optical device is fabricated of a material almost free from thermal distortion (such as a glass substrate), the coefficient a is considered as “1”, and the advantage of the present invention may be enjoyed. The statement that the pitch of the second terminal bank is 1/b times the pitch of the first terminal bank means that the pitch of the second terminal bank is equal to or greater than (1/b−0.001) times and equal to or smaller than (1/b+0.001) times the pitch of the first terminal bank.

### BRIEF DESCRIPTION OF THE DRAWINGS

FIG. 1 is an exploded perspective view showing a liquid-crystal device of one embodiment of the present invention.

FIG. 2 is a sectional view showing the construction of the junction between a liquid-crystal panel and a mount body structure in the liquid-crystal device.

FIG. 3 illustrates the pitch of terminals (in a terminal bank).

FIG. 4 shows the positional relationship between the terminals and alignment marks in the liquid-crystal device.

FIG. 5 is a sectional view showing an alignment step in the manufacturing method of the liquid-crystal device.

FIG. 6(a) is a sectional view showing a bonding step in its midway point in the manufacturing method of the liquid-crystal device, and

FIG. 6(b) is a sectional view showing the liquid-crystal device subsequent to the bonding step.

FIG. 7(a) is a plan view showing the liquid-crystal device immediately subsequent to the alignment step, and FIG. 7(b) is a plan view showing the construction of the liquid-crystal device immediately subsequent to the bonding step.

FIG. 8 is a perspective view showing a mobile telephone as one example of electronic equipment incorporating the electro-optical device of the present invention.

### DETAILED DESCRIPTION OF THE PREFERRED EMBODIMENTS

Referring to the drawings, the embodiments of the present invention are now discussed. The embodiments are presented for illustrative purposes, and are not intended to limit the scope of the present invention. These embodiments may be modified within the scope and spirit of the present invention.

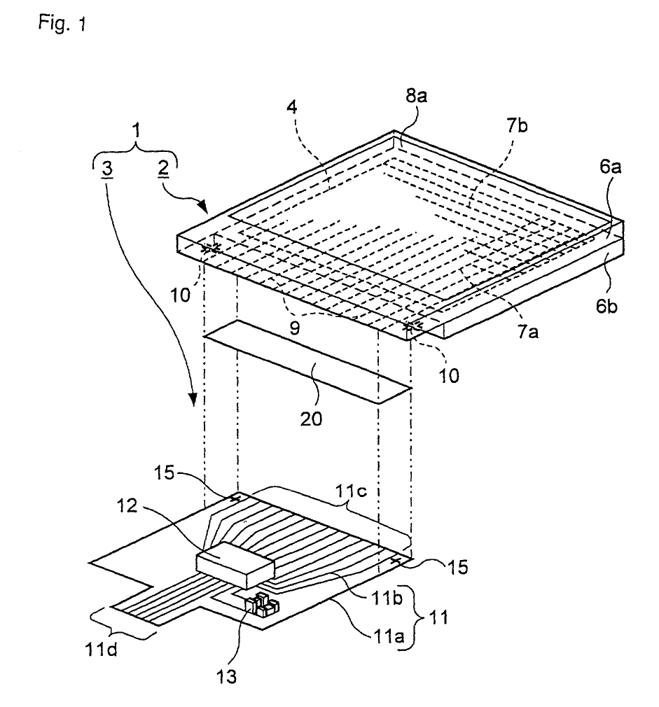

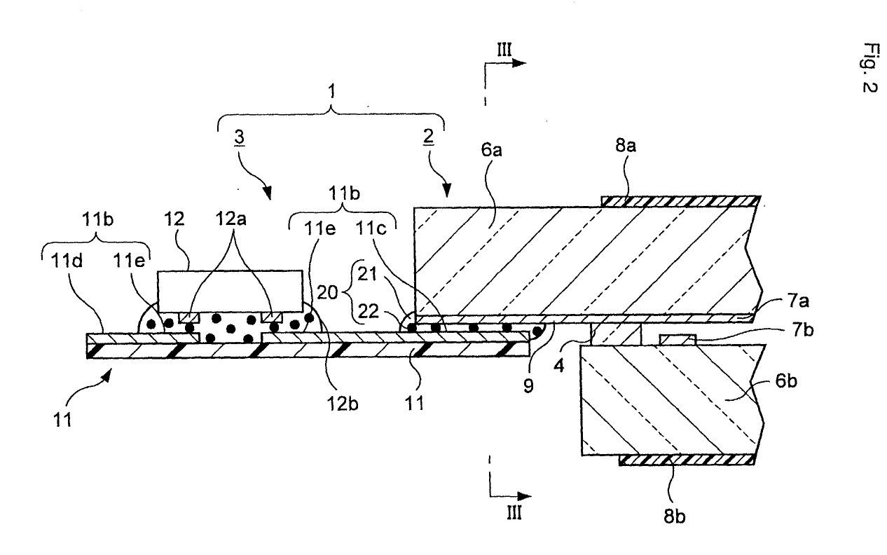

An embodiment of the present invention incorporating a liquid-crystal device employing a liquid crystal as an electro-optical material is now discussed. FIG. 1 is an exploded perspective view showing the liquid-crystal device of one embodiment of the present invention, and FIG. 2 is a partial sectional view of the liquid-crystal device. As shown, the liquid-crystal device 1 includes a liquid-crystal panel 2 and a mount body structure 3 which is bonded to the liquid-crystal panel 2 through an ACF (Anisotropic Conductive Film) 20. The ACF 20 is a high polymeric film for electrically connecting a pair of terminals in an anisotropic fashion. Specifically, the ACF 20 is an adhesive resin 21 having thermoplasticity or thermo-setting property with numerous conductive particles 22 dispersed therewithin. Besides the mount body structure 3, an illumination device and other additional devices are mounted on the liquid-crystal panel 2, but these are not discussed here because they are not closely related to the present invention.

The liquid-crystal panel 2 includes a pair of substrates 6a and 6b bonded through a sealing member 4 therebetween, and a liquid crystal encapsulated in a spacing (a so-called cell gap) between the two substrates. The substrates 6a and 6b are planar members fabricated of a transparent material such as glass or synthetic resin. Specifically, the planar member fabricated of soda-lime glass, nonalkali glass, borosilic acid glass, quartz glass, or silicon substrate may be used for the substrates 6a and 6b. The liquid-crystal panel is typically formed of glass containing, as the major composition thereof, silica (SiO₂), alumina (Al₂O₃), barium oxide (Bao), boron oxide (B₂O₃) strontium oxide (SrO), or calcium oxide (CaO). Polarizers 8a and 8b for polarizing a incident light beam are respectively attached on the external surfaces of the substrates 6a and 6b (opposed to the side of the liquid crystal).

The internal surface of the substrate 6a (to the side of the liquid crystal) is covered with an electrode 7a. The internal surface of the substrate 6b is covered with electrodes 7b. The electrode 7a and the electrodes 7b, fabricated of an electrically conductive transparent material such as ITO (Indium Tin Oxide), are formed in stripes or in an appropriate pattern to display characters, numerals, and other symbols. Although the electrodes 7a and 7b, and terminals 9 are actually arranged in numerous numbers in an extremely fine pitch on the substrates 6a and 6b, these are diagrammatically shown with spacings therebetween enlarged for simplicity, and only several of these are shown with the rest of them omitted from the drawings.

The substrate 6a has an overhang portion (hereinafter referred to as an extension portion) extending over the area of the substrate 6b, and a plurality of terminals 9 is formed on the extension portion. The terminals 9 are formed in the same step as that for forming the electrodes 7a on the substrate 6a. The terminals 9 are fabricated of an electrically conductive transparent material such as ITO. Some of the terminals 9 are formed on the extension portion as extensions from the electrodes 7a on the substrate 6a and the other terminals 9 are connected to the electrodes 7b on the substrate 6b via conductive members (not shown). Referring to FIG. 1, alignment marks 10 are respectively arranged on both sides of the terminal bank of terminals 9. The alignment marks 10 are used to align the substrate 6a to the mount body structure 3 when the substrate 6a is bonded to the mount body structure 3.

The mount body structure 3 includes a wiring board 11, a liquid crystal driver IC 12 and a chip component 13 mounted on the wiring board 11. The wiring board 11 includes a base member 11a and a wiring pattern 11b of copper (Cu) formed thereon. The base member 11a is a film member having flexibility, and is fabricated of polyimide or polyester, for example. The linear thermal expansion coefficient of the base member 11a is greater than the linear thermal expansion coefficient of the substrate 6a to which the base member 11a is bonded. The wiring pattern 11b may be rigidly attached onto the surface of the base member 11a using an adhesive agent, or may be directly formed on the surface of the base member 11a using a film forming technique such as sputtering or roll coating. The wiring board 11 may be produced by forming a wiring pattern 11b of copper on the surface of the base member such as an epoxy substrate being relatively hard and having a thickness.

Referring to FIG. 1 and FIG. 2, some of the wiring patterns 11b extend from output terminals 11c in the vicinity of one edge of the mount body structure 3 to the liquid-crystal driver IC 12 and the other wiring pattern 11b extend from input terminals 11d in the vicinity of the other edge of the mount body structure 3 to the liquid-crystal driver IC 12. The output terminals 11c are electrically connected to the terminals 9 on the substrate 6a via the electrically conductive particles 22 in the ACF 20 when the mount body structure 3 is bonded to the substrate 6a with the ACF 20 interposed therebetween.

Referring to FIG. 2, the liquid-crystal driver IC 12 is mounted on the wiring board 11 with an ACF 12b interposed therebetween, like the ACF 20. Each wiring pattern 11b is connected with a connection terminal 11e thereof in the vicinity of the liquid-crystal driver IC 12 connected to a respective bump (a projecting electrode) 12a of the liquid-crystal driver IC 12. Referring to FIG. 2, the liquid-crystal driver IC 12 is rigidly affixed on the wiring board 11 through an adhesive agent of the ACF 12b while the connection terminal lie of the wiring pattern 11b is electrically connected to the respective bump 12a of the liquid-crystal driver IC 12 via the conductive particles within the ACF 12b. The base member 11a of the wiring board 11 may employ an flexible board, and components may be mounted on the surface thereof. A COF (Chip On Film) mount structure thus results. The base member 11a of the wiring board 11 may employ a hard board, and components may be mounted thereon. A COB (Chip On Board) mount structure thus results.

Referring to FIG. 1, alignment marks 15 are respectively arranged on the terminal bank of the output terminals 11c on the wiring board 11. The alignment marks 15 are produced in the same step as that for forming the wiring patterns 11b. In cooperation with the alignment marks 10, the alignment marks 15 are used to align the substrate 6a with the mount body structure 3.

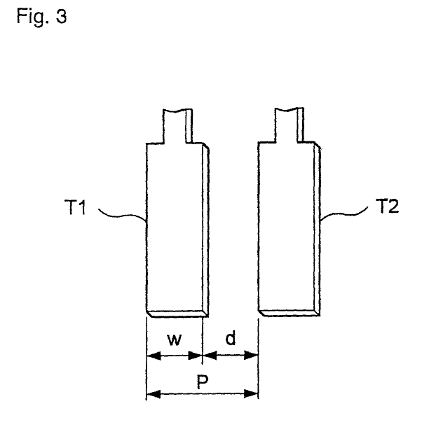

Discussed next is the relationship between the pitch of the terminals 9 on the substrate 6a and the pitch of the output terminals 11c on the wiring board 11, and the relationship between the distance between the alignment marks 10 on the substrate 6a and the distance between the alignment marks 15 on the wiring board 11. The “pitch of the terminals (in terminal bank” is defined as a distance between any given terminal and one terminal next to it. As shown in FIG. 3, for example, terminals T1 and T2 (of the terminals 9 or the output terminals 11c) are considered. The pitch P of the terminals (in the terminal bank) in this case is the sum of a width w of the terminal T1 and a spacing d between one side of the terminal T1 and the terminal T2. In this embodiment, the width w of each terminal is approximately equal to the spacing d between the adjacent terminals.

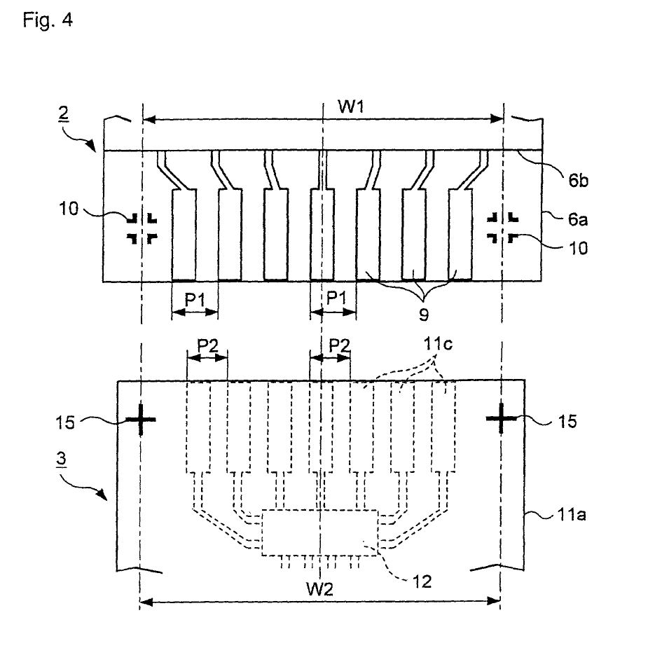

FIG. 4 is a bottom view of the substrate 6a and the wiring board 11 of this embodiment shown in FIG. 1. FIG. 4 shows the substrate 6a and the wiring board 11 in the state thereof prior to bonding. In the bonding step of the substrate 6a and the wiring board 11, the ACF 20 interposed therebetween is heated while the wiring board 11 is pressed against the substrate 6a. During the thermal compression bonding, the wiring board 11 is also heated, and thermally expands. In this embodiment, the pitch P2 of the output terminals 11c and the distance W2 between the alignment marks 15 are determined taking into consideration the thermal distortion of the wiring board 11 subsequent to thermal expansion. Specifically, referring to FIG. 4, prior to the bonding of the substrate 6a to the wiring board 11, the distance W2 between the pair of the alignment marks 15 formed on the wiring board 11 is approximately equal to the distance W1 between the pair of the alignment marks 10 formed on the substrate 6a.

In the state described above, the pitch P2 of the output terminals 11c of the wiring board 11 is different from the pitch P1 of the terminals 9 on the substrate 6a. Since the linear thermal expansion coefficient of the wiring board 11 is larger than the linear thermal expansion coefficient of the substrate 6a in this embodiment, the degree of expansion of the wiring board 11 is larger than that of the substrate 6a, taking place in the thermal compression bonding. The pitch P2 of the output terminals 11c of the wiring board 11 is set to be smaller than the pitch P1 of the terminals 9 of the substrate 6a so that the pitch P2′ of the output terminals 11c of the wiring board 11 subsequent to thermal expansion approximately equals the pitch PI′ of the terminals 9 of the substrate 6a subsequent to the thermal compression bonding. By setting the pitches of the terminals and the spacings of the alignment marks as will be discussed in more detail, the ease of alignment operation is assured while the connection reliability subsequent to the thermal compression bonding is improved.

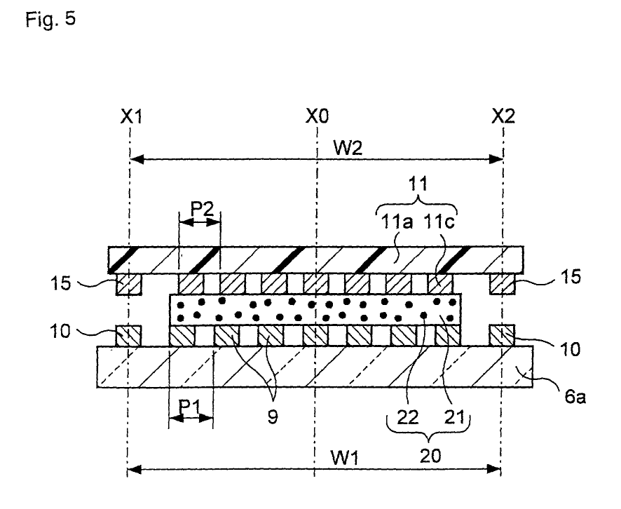

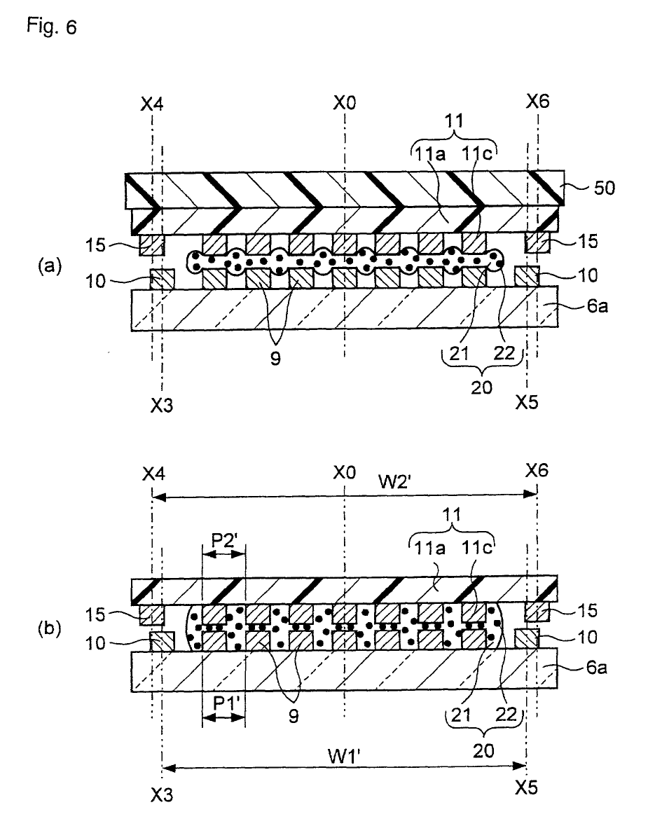

The bonding process of the liquid-crystal panel 2 to the mount body structure 3 is discussed, referring to FIG. 5 and FIGS. 6(a) and 6(b), similar to cross-sectional view taken along line III-III in FIG. 2. The bonding process for bonding the liquid-crystal panel 2 to the mount body structure 3 includes an alignment step for preliminarily fixing the liquid-crystal panel 2 to the mount body structure 3 with the liquid-crystal panel 2 aligned with the mount body structure 3, and a bonding step for thermal compression bonding the substrate 6a to the wiring board 11. These steps are now discussed. Referring to FIG. 5 and FIGS. 6(a) and 6(b), the number of the terminals 9 and the number of the output terminals 11c are shown smaller than actual numbers.

In the alignment step, the ACF 20 being adhesive is applied on a portion of one of the substrate 6a and the wiring board 11 which is to be bonded to the other of the substrate 6a and the wiring board 11. The liquid-crystal panel 2 is aligned with the mount body structure 3 so that the alignment marks 10 of the substrate 6a register with the alignment marks 15 of the wiring board 11. Specifically, the liquid-crystal panel 2 is adjusted in the relative position thereof with respect to the mount body structure 3 so that the alignment marks 10 register with the alignment marks 15, while monitoring the alignment marks 10 and the alignment marks 15 from the side of the substrate 6a using a CCD camera. Subsequent to the alignment step, the substrate 6a is preliminarily fixed to the mount body structure 3 with the liquid-crystal panel 2 and the mount body structure 3 maintained in positional relationship. Referring to FIG. 5, the substrate 6a and the wiring board 11 are preliminarily fixed to each other by putting each of the substrate 6a and the wiring board 11 into contact with the ACF 20 by means of adhesion of the ACF 20. Referring to FIG. 5, the center position of each of the alignment marks 10 and the alignment marks 15 is represented by “X1”, and “X2”, and the midway point between each pair of the alignment marks is represented by “X0”.

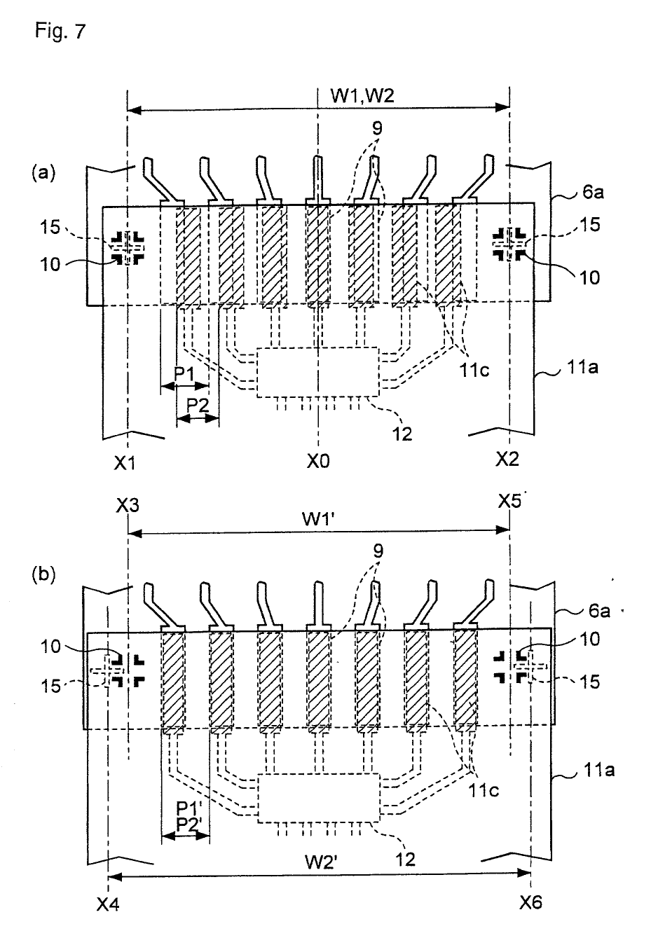

FIG. 7(a) is a plan view showing the substrate 6a and the wiring board 11 in the state thereof shown in FIG. 5, and viewed from above. As already described, the spacing W1 between the pair of alignment marks 10 on the substrate 6a and the spacing W2 between the pair of alignment marks 15 on the wiring board 11 are substantially equal to each other prior to the thermal compression bonding of the substrate 6a to the wiring board 11. Referring to FIG. 7(a), the positional alignment operation between the substrate 6a and the wiring board 11 is easily performed by stacking the substrate 6a on the wiring board 11 so that the alignment marks 10 on the substrate 6a register with the alignment marks 15 on the wiring board 11. As already discussed, prior to the thermal compression bonding, the pitch P2 of the output terminals 11c of the wiring board 11 is smaller than the pitch P1 of the terminals 9 on the substrate 6a. Subsequent to the alignment step, the terminals 9 are not aligned with the output terminals 11c as shown in FIG. 5 and FIG. 7(a).

The bonding step for bonding the liquid-crystal panel 2 to the wiring board 11 is performed subsequent to the alignment step. Referring to FIG. 6(a), a thermal compression bonding head 50 is put into contact with the entire surface of the wiring board 11 opposite to the liquid-crystal panel 2. The thermal compression bonding head 50 heats an object to be bonded while pressing the object. The thermal compression bonding head 50 presses the wiring board 11 against the liquid-crystal panel 2. Heat generated in the thermal compression bonding head 50 is transferred to the ACF 20 through the wiring board 11. As a result, as shown in FIG. 6(a), the adhesive resin 21 of the ACF 20 dissolves, permitting the substrate 6a to move gradually closer to the wiring board 11. Referring to FIGS. 6(a) and 6(b), the positions of the alignment marks 10 on the substrate 6a are represented by “X3” and “X5”. The positions of the alignment marks 15 on the wiring board 11 are represented by “X4” and “X6”.

The thermal compression bonding head 50 continuously presses the wiring board 11 and stops heating when the wiring board 11 and the substrate 6a approach each other in a sufficiently close range. As a result, the adhesive resin 21 of the ACF 20 sets, thereby bonding the substrate 6a to the wiring board 11 with the terminals 9 and the output terminals 11c electrically connected to each other with the conductive particles 22 interposed therebetween.

As the thermal compression bonding head 50 heats the ACF 20 in the bonding step, the wiring board 11 expands, thereby widening the pitch of the output terminals 11c. As discussed above, in this embodiment, the pitch P2 of the output terminals 11c becomes substantially equal to the pitch P1′ of the terminals 9 subsequent to the thermal distortion of the wiring board 11. Referring to FIG. 6(b) and FIG. 7(b), as the wiring board 11 expands in the bonding step, the output terminals 11c having a pitch P2, substantially equal to the pitch of the terminals 9 on the substrate 6a are respectively connected to the terminals 9.

Subsequent to the thermal compression bonding of the substrate 6a to the wiring board 11, the bank of the terminals 9 stretches in the transverse direction thereof (the lateral direction in FIGS. 6(a) and 6(b), and FIGS. 7(a) and 7(b)) by a times on the substrate 6a, and the bank of the output terminals 11c stretches in the transverse direction thereof by b times on the wiring board 11. Hereinafter, the values of “a” and “b”, (referred to as stretch rates) are determined depending on the linear thermal expansion coefficients of the substrate 6a and the output terminals the thickness of the base member 11a or the output terminals 11c, and temperature, pressure, and time for the thermal compression bonding operation. The pitch P2 of the output terminals 11c prior to the thermal compression bonding is set to be a/b times the pitch Pi of the terminals 9 prior to the thermal compression bonding. The statement that the pitch P2 of the output terminals 11c prior to the thermal compression bonding is a/b times the pitch PI of the terminals 9 prior to the thermal compression bonding means that the pitch of the second terminal bank is equal to or greater than (a/b−0.001) times and equal to or smaller than (a/b+0.001) times the pitch P1 of the terminals 9. The pitch P1 of the terminals 9 prior to the thermal compression bonding changes to a pitch P1′=P1×a subsequent to the thermal compression bonding. The pitch P2=P1×a/b of the output terminals 11c prior to the thermal compression bonding changes to a pitch P2′=P1×a subsequent to the thermal compression bonding. In other words, the pitch P1′ of the terminals 9 subsequent to the thermal compression bonding becomes equal to the pitch P2′ of the output terminals 11c. However, when the substrate 6a employs a glass substrate, the substrate 6a practically suffers from no stretching. The stretch rate of the substrate 6a in this case may be set to be “1”. The statement that the pitch P2 of the output terminals 11c prior to the thermal compression bonding is 1/b times the pitch P1 of the terminals 9 prior to the thermal compression bonding means that the pitch of the second terminal bank is equal to or greater than (a/b−0.001) times and equal to or smaller than (a/b+0.001) times the pitch P1 of the terminals 9.

Referring to FIG. 6(b) and FIG. 7(b), the wiring board 11 stretches entirely on the area thereof heated by the thermal compression bonding head 50. Subsequent to the thermal compression bonding, a spacing W2′ between the alignment marks 15 on the wiring board 11 (=W2×b) becomes wider than a spacing W1′ (=W1×a) between the alignment marks 10 on the substrate 6a. As already discussed with reference to FIG. 5, the alignment marks 10 register with the alignment marks 15 prior to the bonding step. Subsequent to the thermal compression bonding, the alignment marks 10 are out of alignment with the alignment marks 15. Even if the alignment marks 10 and the alignment marks 15 are out of alignment (offset from each other) subsequent to the bonding of the substrate 6a to the wiring board 11, no problem is caused as long as they register with each other at the alignment step.

As described above, in accordance with the present embodiment, the pitch of the output terminals 11c is set beforehand to be smaller than the pitch of the terminals 9 to compensate for the stretching of the wiring board 11 taking place in the course of the bonding step. Subsequent to the thermal compression bonding, the pitch of the terminals 9 becomes substantially equal to the pitch of the output terminals 11c. The terminals 9 are thus respectively connected to the output terminals 11c with a high accuracy. Since the spacing between the alignment marks 10 substantially equals the spacing between the alignment marks 15 prior to the thermal compression bonding, aligning the liquid-crystal panel 2 with the mount body structure 3 is performed by adjusting the liquid-crystal panel 2 and the mount body structure 3 until the alignment marks 10 register with the alignment marks 15.

The examples of the present invention are now discussed.

In this example, Capton (trademark) manufactured by Du Pont-Toray Co., Ltd was used for the base member 11a of the wiring board 11. For example, the base member 11a was a member having a thickness within a range from 50 μm to 125 μm and a linear thermal expansion coefficient falling within a range from 2.5×10⁻⁵/K to 2.6×10⁻⁵/K under a measurement temperature range from 100° C. to 200° C. The base member 11a with the output terminals 11c formed thereon became the mount body structure 3. The thermal compression bonding step was then performed under a compression bonding temperature of 170° C., and a compression bonding pressure of 3 MPa for a compression bonding time of 20 seconds. In this case, the wiring board 11 stretched at a rate of 0.3% to 0.4% in the transverse direction thereof of the output terminals 11c (the lateral direction). The pitch of the output terminals 11c was set to be smaller than the pitch of the terminals 9 prior to the thermal compression bonding to compensate for the stretching of the wiring board 11. Specifically, the pitch of the output terminals 11c was set to be 0.996 to 0.997 times the pitch of the terminals 9. The spacing between the alignment marks 15 was set to be substantially equal to the spacing between the alignment marks 10. When the wiring board 11 pitch corrected in this way was thermal compression bonded to the substrate 6a under the above-mentioned thermal compression bonding conditions, the terminals 9 were successfully connected to the output terminals 11c with a high accuracy. By registering the alignment marks 10 with the alignment marks 15, the alignment operation between the liquid-crystal panel 2 and the mount body structure 3 was easily performed.

In this example, UPILEX (tradename) manufactured by Ube Industries, Ltd was used for the base member 11a of the wiring board 11. For example, the base member 11a was a member having a thickness within a range from 5 μm to 75 μm and a linear thermal expansion coefficient falling within a range from 0.8×10⁻⁵/K to 1.0×10⁻⁵/K under a measurement temperature range from 20° C. to 100° C. The wiring board 11 employing the base member 11a was thermal compression bonded to the substrate 6a under conditions of a compression bonding temperature of 170° C., and a compression bonding pressure of 3 MPa for a compression bonding time of 20 seconds. In this case, the wiring board 11 stretched at a rate of 0.2% in the transverse direction thereof on the output terminals 11c. The pitch of the output terminals 11c was set to be smaller than the pitch of the terminals 9 prior to the thermal compression bonding to compensate for the stretching of the wiring board 11. Specifically, the pitch of the output terminals 11c was set to be 0.998 times the pitch of the terminals 9. The spacing between the alignment marks 15 was set to be substantially equal to the spacing between the alignment marks 10. When the wiring board 11 pitch corrected in this way was thermal compression bonded to the substrate 6a under the above-mentioned thermal compression bonding conditions, the terminals 9 were successfully connected to the output terminals 11c with a high accuracy. By registering the alignment marks 10 with the alignment marks 15, the alignment operation between the liquid-crystal panel 2 and the mount body structure 3 was easily performed.

The above-described embodiment of the present invention is for illustrative purpose only and a variety of modifications may be made therewithin without departing the scope of the invention. The following modifications are considered.

In the above-referenced embodiment, the wiring board 11 having the liquid-crystal driver IC mounted thereon is bonded to the substrate 6a of the liquid-crystal panel 2. The liquid-crystal driver IC may be mounted on the substrate 6a using the COG (Chip On Glass) technique. In this case, the wiring board 11 is provided with a wiring pattern for connecting input terminals of the liquid-crystal driver IC to an external circuit board. The present invention finds applications in the electro-optical device as long as the electro-optical device is produced by bonding a base member of an electro-optical panel having terminals in any form and a mount base member (corresponding to the wiring board 11) having terminals to be connected to the first terminals. In this embodiment, the liquid-crystal device includes a single mount body structure 3 connected to the liquid-crystal panel 2. The present invention finds applications in a liquid-crystal device including a plurality of mount body structures 3 connected to the liquid-crystal panel 2.

The manufacturing method of the present invention for manufacturing the electro-optical device is not limited to the case in which the substrate of the electro-optical panel is connected to the mount base member. Specifically, the present invention finds applications in all cases where a first base member with a plurality of first terminals (a first terminal bank) formed thereon is bonded to a second base member with a second terminal (a second terminal bank) to be respectively connected to the first terminals.

In the preceding embodiment, the present invention is applied to the liquid-crystal device employing the liquid crystal as the electro-optical material. The electro-optical device to which the present invention is applied is not limited to this type. The present invention may be applied to a variety of devices, which presents a display using the electro-optical effect of an electro-optical material, including an EL (electroluminescence) display device using an EL element as an electro-optical material, or a plasma display panel using a gas as an electro-optical material. The present invention is applicable to any device which is produced by bonding a substrate having terminals to a mount base member having terminals connected to the first terminals.

In the above embodiment, glass is used for the substrate 6a of the liquid-crystal panel 2. Alternatively, plastic may be used for the substrate 6a. The plastic can be polycarbonate, acrylate (acrylic ester resin, and methacrylate ester resin), PES (polyether sulfonate), PAr (polyarilate), or PhE (phenoxy ether).

As already discussed, the pitch P2 of the output terminals 11c prior to the thermal compression bonding is set to be approximately 1/b times the pitch P1 of the terminals 9 prior to the thermal compression bonding when the substrate 6a is fabricated of a material having a small linear thermal expansion coefficient (i.e., a material hard to expand), such as glass. When the substrate 6a is fabricated of a material containing plastic having a relatively large linear thermal expansion coefficient (i.e., a material easy to expand), both stretch rates a and b are preferably considered. Rather than approximating the stretch rate a to be “1”, the pitch P2 of the output terminals 11c prior the thermal compression bonding is preferably set to be a/b times the pitch P1 of the terminals 9 prior to the thermal compression bonding.

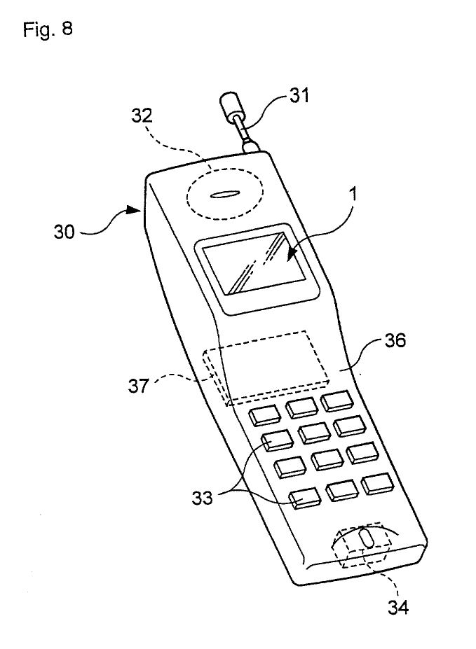

Electronic equipment using the electro-optical device of the present invention is now discussed. FIG. 8 is a perspective view showing a mobile telephone as one example of such electronic equipment. As shown, the mobile telephone 30 includes components such as an antenna 31, a loudspeaker 32, an electro-optical device 1, key switches 33, and a microphone 34, and an outer casing 36 for housing these components. Also arranged in the outer casing 36 is a control circuit board 37 having a control circuit thereon for controlling the operation of the components. The electro-optical device 1 is constructed of the liquid-crystal device of each of the embodiments of the present invention.

The control circuit board 37 receives signals input to the key switches 33 and the microphone 34 and data received by the antenna 31. The control circuit displays numerals, characters, and pictures on the screen of the electro-optical device in response to a variety of input data. The control circuit outputs data through the antenna 31.

Besides the mobile telephone shown in FIG. 8, the electronic equipment incorporating the electro-optical device of the present invention may be any of a diversity of electronic equipment including a liquid-crystal display television, a viewfinder type or direct monitoring type video cassette recorder, a car navigation system, a pager, an electronic at pocketbook, an electronic tabletop calculator, a word processor, a workstation, a video phone, a POS terminal, a digital still camera, and a projector employing the electro-optical device of the present invention as a light valve.

In accordance with the present invention, the terminals on the substrate and the terminals on the mount base member are connected with a high accuracy even when the substrate and the mount base member suffer from distortion during the bonding of the substrate to the mount base member.

What is claimed is:

1. A manufacturing method for manufacturing an electro-optical device having an electro-optical panel with a substrate holding an electro-optical material and a mount base member bonded to the substrate, the manufacturing method comprising a step of connecting a first terminal bank, formed on the surface of the substrate, to a second terminal bank formed on the surface of the mount base member at a pitch different from a pitch of the first terminal bank when the substrate is bonded to the mount base member,
wherein the connection step connects the first terminal bank and the second terminal bank, both of which become substantially equal to each other in pitch when the substrate and the mount base member are deformed during the bonding of the substrate and the mount base member.

2. The manufacturing method for manufacturing an electro-optical device according to claim 1, comprising a step of aligning the substrate with the mount base member prior to the connection step so that a plurality of first alignment marks mutually spaced apart on the surface of the substrate is aligned with a plurality of second alignment marks mutually spaced apart on the surface of the mount base member at a spacing approximately equal to a spacing of the plurality of first alignment marks.

3. The manufacturing method for manufacturing an electro-optical device according to claim 1, wherein, in the connection step, the substrate and the mount base member are bonded together with an adhesive layer interposed between the substrate and the mount base member by heating the adhesive layer.

4. The manufacturing method for manufacturing an electro-optical device according to claim 3, wherein a linear thermal expansion coefficient of the mount base member is larger than a linear thermal expansion coefficient of the substrate, and
wherein the pitch of the second terminal bank is smaller than the pitch of the first terminal bank prior to the connection step.

5. The manufacturing method for manufacturing an electro-optical device according to claim 4, wherein the mount base member is a member having a thickness within a range from 50 μm to 125 μm and a linear thermal expansion coefficient falling within a range from 2.5×10⁻⁵/K to 2.6×10⁻⁵/K under a measurement temperature range from 100° C. to 200° C., and wherein the pitch of the second terminal bank is 0.996 times to 0.997 times the pitch of the first terminal bank.

6. The manufacturing method for manufacturing an electro-optical device according to claim 4, wherein the mount base member is a member having a thickness within a range from 5 μm to 75 μm and a linear thermal expansion coefficient falling within a range from 0.8×10⁻⁵/K to 1.0×10⁻⁵/K under a measurement temperature range from 20° C. to 100° C., and wherein the pitch of the second terminal bank is approximately 0.998 times the pitch of the first terminal bank.

7. The manufacturing method for manufacturing an electro-optical device according to claim 1, wherein the substrate contains a material selected from the group consisting of glass and silicon, and the mount base member contains a material selected from the group consisting of polyimide and polyester.

8. The manufacturing method for manufacturing an electro-optical device according to claim 1, wherein the substrate contains glass, and the mount base member contains polyimide.

9. A terminal connection method for connecting a first terminal bank formed on the surface of a first base member to a second terminal bank formed on the surface of a second base member, the connection method comprising the steps of:
fabricating the second terminal bank at a pitch different from a pitch of the first terminal bank; and
connecting the first terminal bank and the second terminal bank, both of which become substantially equal to each other in pitch when the first base member and the second base member are deformed during the bonding of the first base member to the second base member.

10. The terminal connection method according to claim 9, wherein, in the bonding of the first base member to the second base member, the first base member and the second base member are bonded together with an adhesive layer interposed between the first base member and the second base member by heating the adhesive layer.

11. The terminal connection method according to claim 10, wherein the linear thermal expansion coefficient of the second base member is larger than the linear thermal expansion coefficient of the first base member, and
wherein the pitch of the second terminal bank is smaller than the pitch of the first terminal bank prior to the bonding step.

12. A manufacturing method for manufacturing a mount base member having a second terminal bank to be connected to a first terminal bank formed on a base member and being thermal-compression bonded to the base member, the manufacturing method comprising the step of forming the second terminal bank in such a manner that the pitch of the second terminal bank is a/b times the pitch of the first terminal bank, when, subsequent to the thermal compression bonding of the mount base member to the base member, the first terminal bank expands in width in the transverse direction thereof on the base member by a times and the second terminal bank expands in width in the transverse direction thereof on the mount base member by b times.

13. The manufacturing method for manufacturing a mount base member according to claim 12, wherein the coefficients a and b defining the pitch of the second terminal bank are values determined by a linear thermal expansion coefficient and thermal compression bonding conditions of the mount base member.

14. An electro-optical device comprising:
an electro-optical panel including a substrate holding an electro-optical material;
a mount base member bonded to the substrate;
a first terminal bank formed on the surface of the substrate;
a plurality of first alignment marks formed and mutually spaced apart on the surface of the substrate;
a second terminal bank formed and mutually spaced apart on the mount base member, wherein the second terminal bank is connected to the first terminal bank at a pitch thereof substantially equal to the pitch of the first terminal bank; and
a plurality of second alignment marks formed on the surface of the mount base member, and spaced mutually more apart than the spacing of the first alignment marks.

15. The electro-optical device according to claim 14, wherein one group of the plurality of first alignment marks and the other group of the plurality of first alignment marks are arranged to be opposed to each other with the first terminal bank interposed therebetween, and
wherein one group of the plurality of second alignment marks and the other group of the plurality of second alignment marks are arranged to be opposed to each other with the second terminal bank interposed therebetween.

16. The electro-optical device according to claim 14, wherein the substrate and the mount base member are bonded to each other with an adhesive layer therebetween, and wherein the adhesive layer contains conductive particles dispersed therewithin to conductively connect the first terminal bank to the second terminal bank.

17. The electro-optical device according to claim 14, wherein the mount base member is a film-like member having flexibility.

18. The electro-optical device according to claim 14, wherein the substrate contains a material selected from the group consisting of glass and silicon, and the mount base member contains a material selected from the group consisting of polyimide and polyester.

19. The electro-optical device according to claim 14, wherein the substrate contains glass, and the mount base member contains polyimide.

20. The electro-optical device according to claim 14, wherein the mount base member is a member having a thickness within a range from 50 μm to 125 μm and a linear thermal expansion coefficient falling within a range from 2.5×10⁻⁵/K to 2.6×10⁻⁵/K under a measurement temperature range from 100° C. to 200° C., and
wherein the spacing of the second alignment marks is 1.003 times to 1.004 times the spacing of the first alignment marks.

21. The electro-optical device according to claim 14, wherein the mount base member is a member having a thickness within a range from 5 μm to 75 μm and a linear thermal expansion coefficient falling within a range from 0.8×10⁻⁵/K to 1.0×10⁻⁵/K under a measurement temperature range from 20° C. to 100° C., and
wherein the spacing of the second alignment marks is approximately 1.002 times the spacing of the first alignment marks.

22. Electronic equipment comprising an electro-optical device according to claim 14.

23. A mount base member to be bonded to a substrate of an electro-optical panel, comprising a second terminal bank formed at a pitch different from a pitch of a first terminal bank formed on the substrate and connected to the first terminal bank.

24. A mount base member to be thermal compression bonded to a substrate of an electro-optical panel, the mount base member comprising a second terminal bank to be connected to a first terminal bank formed on the substrate, wherein the pitch of the second terminal bank prior to the thermal compression bonding is a/b times the pitch of the first terminal bank, when, subsequent to the thermal compression bonding of the mount base member to the substrate, the first terminal bank expands in width in the transverse direction thereof on the substrate by a times and the second terminal bank expands in width in the transverse direction thereof on the mount base member by b times.

25. A mount base member to be thermal compression bonded to a substrate of an electro-optical panel, the mount base member comprising a second terminal bank to be connected to a first terminal bank formed on the substrate, wherein the pitch of the second terminal bank prior to the thermal compression bonding is 1/b times the pitch of the first terminal bank, when, subsequent to the thermal compression bonding of the mount base member to the substrate, the second terminal bank expands in width in the transverse direction thereof on the mount base member by b times.
